(19) United States
(12) Patent Application Publication
(10) Pub. No.: US 2026/0098232 A1
(43) Pub. Date: Apr. 9, 2026

(54) ANTI-REDEPOSITION COMPOSITION

(71) Applicant: NOURYON CHEMICALS INTERNATIONAL B.V., Amsterdam (NL)

(72) Inventors: Nea Janette LINTULA, Jyväskylä (FI); Reeta-Maaret Emilia SALMINEN, Jyväskylä (FI); Veera Susanna LAAJALA, Laukaa (FI); Conrardus Hubertus Joseph THEEUWEN, Duiven (NL); Robert Wilhelm VAN GEMERT, Velp (NL)

(73) Assignee: NOURYON CHEMICALS INTERNATIONAL B.V., Amsterdam (NL)

(21) Appl. No.: 19/259,781

(22) Filed: Jul. 3, 2025

(30) Foreign Application Priority Data
Jul. 5, 2024 (EP) 24186966.8

(51) Int. Cl. C11D 3/37; C11D 1/04; C11D 1/22; C11D 1/28; C11D 1/72; C11D 1/831; C11D 17/00; C11D 17/06

(52) U.S. Cl. CPC C11D 3/3707; C11D 1/04; C11D 1/22; C11D 1/28; C11D 1/72; C11D 1/831; C11D 17/0008; C11D 17/06

(57) ABSTRACT

A detergent composition includes a pectin and a polysaccharide derivative, such as a carboxymethylcellulose.

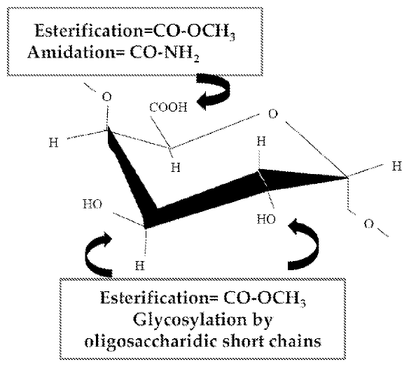

### CROSS-REFERENCE TO RELATED APPLICATIONS

This application claims the benefit of European Patent Application No. EP24186966.8, filed on Jul. 5, 2024, which is expressly incorporated herein by reference in its entirety.

### TECHNICAL FIELD

The present disclosure relates to a detergent composition comprising a pectin and a polysaccharide derivative, typically carboxymethyl cellulose, and its use as an anti-redeposition agent for synthetic fibers.

### BACKGROUND

It is known that conventional detergents generally contain a blend of anionic and nonionic surfactants to optimize performance and cost effectiveness. However, surfactants by themselves are known to have insufficient anti-redeposition properties, and therefore using these conventional detergents can lead to greying of textiles, such as fabrics. As a result, anti-redeposition agents, such as carboxymethyl cellulose (CMC), are used in combination with these surfactants. CMC functions as an anti-redeposition agent by being selectively absorbed by textiles, such as cotton-based textiles, through hydrogen bonding. The anti-redeposition properties of CMC are due to the electrostatic repulsion between negatively charged dirt particles and the negative charge of the carboxymethyl groups. Thus, the CMC functions in detergents as, among other things, a dirt carrier and prevents secondary deposition on the textiles. Despite CMC being a widely used anti-redeposition agent in laundry detergents that is known to perform well on cellulosic fibers (cotton, linen, rayon, lyocell, cupro and the likes), CMC has little to no performance on synthetic fibers (polyester, nylon, polyacrylate, etc.).

Various objects, desirable features and characteristics will become apparent from the subsequent summary and detailed description, and the appended claims, taken in conjunction with the accompanying drawing and this background.

### SUMMARY

This disclosure provides a detergent composition that includes a pectin and a polysaccharide derivative. This disclosure also provides a method of washing a synthetic fabric including the step of contacting the synthetic fabric with a wash liquor including the detergent composition.

### BRIEF DESCRIPTION OF THE DRAWING

The present disclosure will hereinafter be described in conjunction with the following FIGURE wherein the FIGURE is a schematic illustrating the substitution points of galacturonic acid.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

It was an aim of the present disclosure to find a way to improve the anti-redeposition performance of CMC on synthetic fibers.

A surprising finding was that this objective could be fully realized by blending CMC with pectin, with an unexpected synergy being observed when washing synthetic fibers with the CMC/pectin blend. Further studies found that this unexpected synergy could also be observed for combinations of pectin with other polysaccharide derivatives, such as amylose-polyacrylate hybrid polymer.

Accordingly, in a first aspect, the present disclosure relates to a detergent composition comprising a pectin and a polysaccharide derivative. Typically, the polysaccharide derivative is a carboxymethyl cellulose.

In a second aspect, the present disclosure relates to a method of cleaning soiled synthetic fibers comprising contacting said soiled synthetic fibers with a detergent composition comprising a pectin and a polysaccharide derivative, typically a carboxymethyl cellulose.

In a third aspect, the present disclosure relates to the use of a blend of pectin and a polysaccharide derivative, typically a carboxymethyl cellulose, as an anti-redeposition agent for synthetic fibers.

Improved detergent compositions for synthetic fibers have been developed, particularly detergent compositions that include a carboxymethyl cellulose (CMC) and a pectin.

As used herein, detergent compositions include powder or liquid laundry detergents. The detergent compositions described herein may be made using any known methods. For example, the method may include adding a CMC/pectin blend to a surfactant system to form a detergent mixture. The surfactant system may be in the form of a liquid, or it may be in solid particulate form. Where the surfactant system is in liquid form, the CMC/pectin blend may be in liquid form when it is added to the liquid surfactant system, or the CMC/pectin blend may be in particulate form when it is added to the liquid surfactant system. Where the surfactant system is in particulate form, the CMC/pectin blend may be in liquid form when it is added to the particulate surfactant system, or the CMC/pectin blend may be in particulate form when it is added to the particulate surfactant system.

As used herein, a “polysaccharide derivative” is a polysaccharide that has been subject to chemical modification of the polysaccharide backbone. For the avoidance of doubt, the polysaccharide derivative and the pectin with which it is combined are distinct components of the detergent composition disclosed herein. Chemical modifications include, but are not necessarily limited to, etherification, esterification, amination, amidation, graft copolymerization, etc. Non-limiting examples of polysaccharide derivatives include cellulose derivatives (e.g., cellulose esters, cellulose ethers), and starch derivatives (e,g, amylose-polyacrylate hybrid copolymers). Polysaccharide derivatives comprising a plurality of carboxyl functionalities are typical, such as carboxymethyl celluloses (CMCs) and polysaccharide-polyacrylate hybrid polymers, CMCs being the most typical polysaccharide derivative of the present disclosure.

As used herein, molecular weight (Mw) is the weight average molecular weight as determined by GPC (Pullulan standards). For example, Mw and, if applicable, Mp (molecular weight peak), is determined using a GPCmax VE GPC solvent/sample module (Viscotek), column oven, 270 Dual Detector and Shodex RI-71 using a narrow standard Pullulan to calibrate the system. A detailed methodology is provided in “Protocol 1” of WO 2018/060262, which is hereby incorporated by reference.

Values or ranges may be expressed herein as “about”, from “about” one particular value, and/or to “about” another particular value. When such values or ranges are expressed, other aspects disclosed include the specific value recited, from the one particular value, and/or to the other particular value. Similarly, when values are expressed as approximations, by use of the antecedent “about,” it will be understood that the particular value forms another aspect. It will be further understood that there are a number of values disclosed therein, and that each value is also herein disclosed as “about” that particular value in addition to the value itself. In aspects, “about” can be used to mean, for example, within 10% of the recited value, within 5% of the recited value, or within 2% of the recited.

Several aspects of detergent compositions and methods of manufacture are described herein. Parameters of different steps, components, and features of the aspects are described separately, but may be combined consistently with this description of claims to enable other aspects as well to be understood by those skilled in the art. Various terms used herein are likewise defined in the description which follows. Concentrations and percentages are in weight percent (wt. %) unless the context indicates otherwise.

The detergent compositions of the present disclosure require, as a first component, a polysaccharide derivative. Typical polysaccharide derivatives are cellulose derivatives, such as cellulose ethers and cellulose esters, typically cellulose ethers. Non-limiting examples of cellulose ethers include alkyl and/or hydroxyalkyl cellulose ethers (e.g., hydroxyethyl cellulose (HEC), ethyl hydroxyethyl cellulose (EHEC), methyl hydroxyethyl cellulose (MHEC), methyl ethyl hydroxyethyl cellulose (MEHEC), methyl cellulose, ethyl cellulose, etc.), and carboxymethyl celluloses. The most typical polysaccharide derivative of the present disclosure is a carboxymethyl cellulose. Suitable carboxymethyl cellulose has a structure according to the formula:

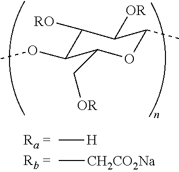

The carboxymethyl cellulose component may be, but is not necessarily limited to, a carboxymethyl cellulose salt, such as sodium carboxymethyl cellulose, or modified carboxymethyl cellulose, such as, but not necessarily limited to, hydrophobic-modified CMC, cationic-modified CMC, or sulfate- or sulfonate-modified CMC. The interchangeability of the use of carboxymethyl cellulose and its modified forms in detergent applications is well known in the art as described in EP2302025B1 and U.S. Pat. No. 6,600,033, both of which are incorporated by reference herein. Reference herein to carboxymethyl cellulose (CMC) component is also meant to include modifications thereof. In a typical embodiment, the carboxymethyl cellulose is sodium carboxymethyl cellulose.

In one embodiment, the carboxymethyl cellulose component may have a molecular weight of from 1,000 Daltons (Da) to 300,000 Da, such as from 1,000 Da to 250,000 Da, or 1,000 Da to 200,000 Da, or 1,000 Da to 150,000 Da, or 1,000 Da to 100,000 Da. Alternatively, the carboxymethylcellulose may have a molecular weight of from 10,000 Da to 300,000 Da, such as from 50,000 Da to 250,000 Da, or from 100,000 Da to 200,000 Da.

In a typical embodiment, the carboxymethyl cellulose component is an “ultra-low molecular weight” carboxymethyl cellulose as described in WO 2018/060262, which is hereby incorporated by reference, and which defines an “ultra-low molecular weight” as a molecular weight (Mw) of from about 1,000 Dalton (Da) to about 80,000 Dalton (Da). Accordingly, the ultra-low molecular weight CMC may have a molecular weight of from about 1,000 Da to 80,000 Da, such as from about 1,000 Da to about 40,000 Da, or from about 1,000 Da to about 30,000 Da, or from about 1,000 Da to about 15,000 Da. For example, the ultra-low molecular weight CMC may have a molecular weight of 1,000 Da, 2,000 Da, 3,000 Da, 4,000 Da, 5,000, Da, 6,000 Da, 7,000 Da, 8,000 Da, 9,000 Da, 10,000 Da, 11,000 Da, 12,000 Da, 13,000 Da, 14,000, Da, 15,000 Da, 16,000 Da, 17,000 Da, 18,000 Da, 19,000 Da, 20,000 Da, 21,000 Da, 22,000 Da, 23,000 Da, 24,000 Da, 25,000 Da, 26,000 Da, 27,000 Da, 28,000 Da, 29,000 Da, 30,000 Da, 31,000 Da, 32,000 Da, 33,000 Da, 34,000 Da, 35,000 Da, 36,000 Da, 37,000 Da, 38,000 Da, 39,000 Da, 40,000 Da, 41,000 Da, 42,000 Da, 43,000 Da, 44,000 Da, 45,000 Da, 46,000 Da, 47,000 Da, 48,000 Da, 49,000 Da, 50,000 Da, 51,000 Da, 52,000 Da, 53,000 Da, 54,000 Da, 55,000 Da, 56,000 Da, 57,000 Da, 58,000 Da, 59,000 Da, 60,000 Da, 61,000 Da, 62,000 Da, 63,000 Da, 64,000 Da, 65,000 Da, 66,000 Da, 67,000 Da, 68,000 Da, 69,000 Da, 70,000 Da, 71,000 Da, 72,000 Da, 73,000 Da, 74,000 Da, 75,000 Da, 76,000 Da, 77,000 Da, 78,000 Da, 79,000 Da, or 80,000 Da. The ultra-low molecular weight CMC may also have a molecular weight between any of these recited molecular weights. The ultra-low molecular weight CMC component may have a molecular weight distribution that is unimodal, bimodal, or multimodal and in each case the molecular weight peaks (Mp) are no greater than 80,000 Da. For example, the molecular weight peaks may be from about 750 to 60,000 Da.

In any one of the above embodiments, the carboxymethyl cellulose component of the detergent composition may be a combination of smaller molecular weight and larger molecular weight carboxymethyl celluloses so that a bimodal or multimodal molecular weight distribution is achieved. For example, the carboxymethyl cellulose component may have a bimodal molecular weight distribution, wherein the first molecular weight modal has a peak in the range of from 1,000 Da to 80,000 Da, and wherein the second molecular weight modal has a peak in the range of from 100,000 Da to 300,000 Da.

In any one of the above embodiments, the carboxymethyl cellulose component may have a degree of substitution (DS) of no more than 1.5, typically less than 0.8. In one embodiment, the CMC component may have a DS of from about 0.2 to about 1.5. For example, the CMC component may have a DS from about 0.2 to about 1.0. In a typical embodiment, the CMC component has a DS of from about 0.3 to about 0.8. The term “degree of substitution” or “DS” means the average number of substituted ring sites of the beta-anhydroglucose rings of the cellulose derivative. Since there are three hydroxyl groups (R) on each anhydroglucose ring of the cellulose that are available for substitution, the maximum value of DS is 3.0. For carboxymethyl cellulose, each R group will comprise either Ra or Rb (see above formula) with the ‘degree of substitution’ being defined as the average number of R groups per repeating cellulose unit that comprise Rb. Generally, the degree of substitution may be measured by any techniques known in the art. For example, the degree of substitution, including those disclosed herein, may be measured by the following analysis method: a sample of CMC at a known weight was burned to ash, i.e., heated for 45 minutes at 650° C., then cooled to 25° C.; the cooled sample was then dissolved in distilled water having a temperature of 80° C. to form a sample mixture; the sample mixture was then cooled to 70° C., and thereafter titrated by 0.1N sulphuric acid by using methyl red as the indicator. The degree of substitution (DS) is calculated by the following formula, where b is the amount of acid consumption (mL) and G is the weight of the sample (grams):

$$Degree of Substitution ( DS ) = \frac{0.162 * 0.1 ( \frac{b}{G} )}{1 - ( 0.08 * 0.1 ( \frac{b}{G} ) )}$$

In any one of the above embodiments, the carboxymethyl cellulose may have a degree of substitution (DS) in the range of from 0.01 to 0.99 and a degree of blockiness (DB) such that the sum of DS+DB is at least 0.30, or at least 0.40, or at least 0.50, or at least 0.60, or at least 0.70, or at least 0.80, or at least 0.90, or at least 1.00, or at least 1.05, or at least 1.10, or at least 1.15, or at least 1.20, or at least 1.25, or at least 1.30, or at least 1.35, or at least 1.40, or at least 1.45, or at least 1.50. The carboxymethyl cellulose may have a degree of substitution (DS) in the range of from 0.01 to 0.99 and a degree of blockiness (DB) such that the sum of DB+2DS-DS² is at least 1.00, or at least 1.10, or at least 1.20, or at least 1.25, or at least 1.30, or at least 1.35, or at least 1.40, or at least 1.45, or at least 1.50. In one embodiment, the carboxymethyl cellulose is a hydrophobically modified carboxymethylcellulose having a degree of substitution (DS) of from 0.01 to 0.99 and a degree of blockiness (DB) such that either DS+DB is of at least 1.00 and/or DB+2DS-DS² is at least 1.20. Method to determine degree of blockiness (DB) of a carboxymethyl cellulose (CMC): In the case of a substituted cellulose, the DB may correspond to the amount (A) of non-substituted glucose units released after a specific enzymatic hydrolysis with the commercial endoglucanase enzyme (Econase CE, AB Enzymes, Darmstadt, Germany) divided by the total amount of non-substituted glucose units released after acid hydrolysis (A+B). The enzymatic activity is specific to non-substituted glucose units in the polymer chain that are directly bounded to another non-substituted glucose unit. The enzymatic degradation is performed using the enzyme (Econase CE) in a buffer at pH 4.8 at 50° C. for 3 days. To 25 ml of substituted cellulose sample, 250 mL of enzyme is used. The degradation is stopped by heating the samples to 90° C. and keeping them hot for 15 minutes. The acid hydrolysis for both substitution pattern and blockiness is carried out in perchloric acid (15 min in 70% HClO₄ at room temperature and 3 hours in 6.4% HClO₄ at 120° C.). The samples are analysed using Anion Exchange Chromatography with Pulsed Amperiometric Detection (PAD detector: BioLC50 (Dionex, Sunnyvale, California, USA)). The HPAEC/PAD system is calibrated with 13C NMR. The monosaccharides are separated at 35° C. using a flow rate of 0.2 ml/min on a PA-1 analytical column using 100 mM NaOH as eluent with increasing sodium acetate (from 0 to 1M sodium acetate in 30 mins). Each sample is analysed three to five times and an average is calculated. The number of unsubstituted glucose that were directly linked to at least one substituted glucose (A), and the number of unsubstituted glucose that were not directly linked to a substituted glucose (B) are deduced and the DB of the substituted cellulose sample is calculated: DB=B/(A+B).

In a particularly typical embodiment, the polysaccharide derivative is a carboxymethyl cellulose having a weight average molecular weight of from 1,000 Da to 80,000 Da (GPC, Pullulan standards) and/or a polysaccharide-polyacrylate hybrid polymer. Best results are observed when combining these particular polysaccharide derivatives with a pectin.

The polysaccharide derivative, typically a CMC component, may be present in the detergent composition at a concentration from about 0.005% to about 10% by weight of the detergent composition. For example, the polysaccharide derivative, typically CMC, may be present in the detergent composition at a concentration from about 0.01% to about 5% by weight of the detergent composition. Or, the polysaccharide derivative, typically CMC, may be present in the detergent composition at a concentration from about 0.05% to about 2% by weight of the detergent composition. For example, the polysaccharide derivative, typically CMC, may be present in the detergent composition at a concentration of about 0.005%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.1%, 1.2%, 1.3%, 1.4% 1.5%, 1.6%, 1.7%, 1.8%, 1.9%, 2%, 2.1%, 2.2%, 2.3%, 2.4% 2.5%, 2.6%, 2.7%, 2.8%, 2.9%, 3%, 3.1%, 3.2%, 3.3%, 3.4% 3.5%, 3.6%, 3.7%, 3.8%, 3.9%, 4%, 4.1%, 4.2%, 4.3%, 4.4% 4.5%, 4.6%, 4.7%, 4.8%, 4.9%, 5%, 5.1%, 5.2%, 5.3%, 5.4% 5.5%, 5.6%, 5.7%, 5.8%, 5.9%, 6%, 6.1%, 6.2%, 6.3%, 6.4% 6.5%, 6.6%, 6.7%, 6.8%, 6.9%, 7%, 7.1%, 7.2%, 7.3%, 7.4% 7.5%, 7.6%, 7.7%, 7.8%, 7.9%, 8%, 8.1%, 8.2%, 8.3%, 8.4%, 8.5%, 8.6%, 8.7%, 8.8%, 8.9%, 9%, 9.1%, 9.2%, 9.3%, 9.4% 9.5%, 9.6%, 9.7%, 9.8%, 9.9%, or 10% by weight of the detergent composition. The polysaccharide derivative, typically CMC, may also be present in the detergent composition at a concentration between any of these recited percentages.

The detergent compositions of the present disclosure require, as a second component, a pectin. Pectins are a family of complex polysaccharides present within the primary cell wall and intercellular regions of dicotyledons, more commonly in the outer fruit coat or peel as compared to the inner matrix, that impart flexibility and mechanical strength to plants. Pectin is composed primarily of D-galacturonic acid (GalpA) α-(1,4) linked to form a backbone interrupted by (1,2)-linked β-L-rhamnose (Rhap). The most abundant classes of pectins are homogalacturonan (HG) and rhamnogalacturonan I (RG-I). On the polysaccharide backbone, a proportion of the carboxyl groups can be methyl esterified, giving a degree of methylation (DM), while acetyl groups can esterify GalpA at C2 and/or C3 positions, giving a degree of acetylation (DAc). Furthermore, amidated pectins may be synthetized through the reaction of pectin carboxymethyl groups with ammonia. The FIGURE illustrates the substitution points of galacturonic acid.

The degree of methylation (DM) and the degree of acetylation (DAc) are well-known terms of the art for pectins: DM corresponds to the number of methylated carboxylic functions per 100 units of galacturonic acid in the main chain, and DAc corresponds to the percentage of galacturonosyl residues esterified (on the hydroxyl group) with acetyl. It would be routine for a person skilled in the art to determine these well-understood parameters for any given pectin, e.g., Levigne, S.; Thomas, M.; Ralet, M.-C.; Quemener, B.; Thibault, J.-F. Determination of theDegrees of Methylation and Acetylation of Pectins Using a C18 Column and Internal Standards. Food Hydrocoll. 2002, 16, 547-550.

Pectins are most often obtained by extraction of a wide range of fruit by-products. Commercially available pectins, for example, are generally extracted from citrus (lemon, lime, orange) peels, apple pomace, and sugar beet pulp by acid extraction at pH 1.5-3.0 with conventional heating techniques (60-100° C.) for several hours (Picot-Allain, M.C.N.; Ramasawmy, B.; Emmambux, M.N. Extraction, characterisation, and application of pectin from tropical and sub-tropical fruits: A review. Food Rev. Int. 2020, 1-31). Pectins extracted from plants (e.g., sugar beet) or fruit (e.g., citrus, apple, etc.) are within the scope of the present disclosure, as are chemically modified versions thereof (e.g., amidated pectins). Whilst pectin compositions and structures are strongly dependent on the pectin source, developmental stages of plants, and extraction conditions, it was found that a wide variety of pectins could be used successfully in the detergent composition disclosed herein, including modified pectins; synergy with the CMC component was observed for pectins with a high degree of methylation (>50%), pectins with a low degree of methylation (<50%), pectins with a high degree of acetylation (>10%), pectins with a low degree of acetylation (<10%), and amidated pectins. That said, it was found that pectins with a high degree of acetylation (>10%) yielded the best results. As such, in a typical embodiment, the pectin component of the detergent composition comprises at least one pectin having a degree of acetylation of at least 10%. Preference is also given to pectins with a high degree of methylation (>50%). Most typically, the pectin component comprises at least one pectin having a degree of methylation of at least 50% and a degree of acetylation of at least 10%, such as pectin obtained from sugar beet.

Whilst the molecular weight of natural pectin is usually in the region of 200-800 kDa, low molecular weight pectins (20-200 kDa) can be obtained by treating natural pectin with a pectinase. As such, in one embodiment the pectin component has a molecular weight (Mw) of from about 20,000 Da to about 800,000 Da, with preference for pectins having a Mw of from about 30,000 Da to about 300,000 Da.

The pectin component may be present in the detergent composition at a concentration from about 0.005% to about 10% by weight of the detergent composition. For example, pectin may be present in the detergent composition at a concentration from about 0.01% to about 5% by weight of the detergent composition. Or, pectin may be present in the detergent composition at a concentration from about 0.05% to about 2% by weight of the detergent composition. For example, pectin may be present in the detergent composition at a concentration of about 0.005%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.1%, 1.2%, 1.3%, 1.4% 1.5%, 1.6%, 1.7%, 1.8%, 1.9%, 2%, 2.1%, 2.2%, 2.3%, 2.4% 2.5%, 2.6%, 2.7%, 2.8%, 2.9%, 3%, 3.1%, 3.2%, 3.3%, 3.4% 3.5%, 3.6%, 3.7%, 3.8%, 3.9%, 4%, 4.1%, 4.2%, 4.3%, 4.4% 4.5%, 4.6%, 4.7%, 4.8%, 4.9%, 5%, 5.1%, 5.2%, 5.3%, 5.4% 5.5%, 5.6%, 5.7%, 5.8%, 5.9%, 6%, 6.1%, 6.2%, 6.3%, 6.4% 6.5%, 6.6%, 6.7%, 6.8%, 6.9%, 7%, 7.1%, 7.2%, 7.3%, 7.4% 7.5%, 7.6%, 7.7%, 7.8%, 7.9%, 8%, 8.1%, 8.2%, 8.3%, 8.4%, 8.5%, 8.6%, 8.7%, 8.8%, 8.9%, 9%, 9.1%, 9.2%, 9.3%, 9.4% 9.5%, 9.6%, 9.7%, 9.8%, 9.9%, or 10% by weight of the detergent composition. Pectin may also be present in the detergent composition at a concentration between any of these recited percentages.

In a particularly typical embodiment, the polysaccharide derivative is a carboxymethyl cellulose having a weight average molecular weight of from 1,000 Da to 80,000 Da (GPC, Pullulan standards) and/or a polysaccharide-polyacrylate hybrid polymer, and the pectin is a pectin with a degree of acetylation of >10%. The best results were observed when combining these particular polysaccharide derivatives with these particular pectins.

In one embodiment, the detergent composition disclosed herein comprises a surfactant system at a concentration from about 0.01% to about 70% by weight of the detergent composition. For example, the surfactant system may be present in the detergent composition at a concentration from about 1% to about 40% by weight of the detergent composition. Or, the surfactant system may be present in the detergent composition at a concentration from about 10% to about 40% by weight of the detergent composition. For example, the surfactant system may be present in the detergent composition at a concentration of 0.01%, 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% by weight of the detergent composition. The surfactant system of this disclosure can also be present in the detergent composition at a concentration between any of these recited percentages.

Surfactant systems for detergent compositions are well known in the field of laundry detergents and for that reason are not explained in extensive detail herein. Typical surfactant systems of the present disclosure comprise an anionic surfactant, a nonionic surfactant, or a combination of the anionic surfactant and the nonionic surfactant. Where the surfactant system comprises a combination of anionic and nonionic surfactants, the weight ratio of the anionic surfactant to the nonionic surfactant in the surfactant system is typically from about 30:1 to about 1:1.

Non-limiting examples of suitable anionic surfactants include aliphatic sulphates, aliphatic sulfonates (e.g., C8 to C22 sulfonate or disulfonate), aromatic sulfonates (e.g., alkyl benzene sulfonates), alkyl sulfoccinates, alkyl and acyl taurates, alkyl and acyl sarcosinates, sulfoacetates, alkyl phosphates, carboxylates, isethionates, fatty acids (e.g., C8-C30 fatty acids, such as C8-C18 fatty acids) and any combination thereof. Anionic surfactants are typically used in salt form, such as their respective alkali salt, e.g., sodium salt, but may also be neutralised with an amine, such as monoethanolamine, diethanolamine, triethanolamine or a mixture thereof. Typically, the anionic surfactant comprises linear alkylbenzene sulphonate, alkoxylated alkyl sulphate, fatty acid, or a mixture thereof. In some embodiments, the anionic surfactant is a mixture of linear alkylbenzene sulphonate and alkoxylated alkyl sulphate, more typically a mixture of linear alkylbenzene sulphonate and ethoxylated alkyl sulphate. In some embodiments, the detergent composition may comprise up to 50%, typically between 5% and 50%, more typically between 7.5% and 45%, even more typically between 10% and 40% by weight of the detergent composition of one or more anionic surfactants.

Non-limiting examples of suitable nonionic surfactants include aliphatic alcohols, acids, amides or alkyl phenols with alkylene oxides, sugar amides, alkyl polysaccharides, and the like, and combinations thereof. Typically, the non-ionic surfactant is selected from alcohol alkoxylate, an oxo-synthesised alcohol alkoxylate, Guerbet alcohol alkoxylates, alkyl phenol alcohol alkoxylates or a mixture thereof. Typical are alcohol ethoxylates. In some embodiments, the detergent composition may comprise 0% to 10%, typically 0.01% to 8%, more typically 0.1% to 6% of a one or more non-ionic surfactants.

The surfactant system may also include cationic surfactants, amphoteric surfactants, or combinations thereof. Or, the surfactant system may not include cationic surfactants. The surfactant system may include anionic, nonionic, and amphoteric surfactants. It is also contemplated that the surfactant system does not include any other surfactants other than anionic and/or nonionic surfactants.

The detergent composition disclosed herein may further comprise an adjunct ingredient selected from further polymers, builders, dye transfer inhibiting agents, dispersants, enzymes, enzyme stabilizers, catalytic materials, bleach, bleach activators, polymeric dispersing agents, suds suppressors, aesthetic dyes, opacifiers, perfumes, perfume delivery systems, structurants, hydrotropes, processing aids, pigments and mixtures thereof. Such conventional detergent additives may be included in the detergent composition in their conventional amounts, or may be omitted from the detergent composition.

In one embodiment, the detergent composition disclosed herein is a liquid laundry detergent composition. The term ‘liquid laundry detergent composition’ refers to any laundry detergent composition comprising a liquid capable of wetting and treating a fabric, and includes, but is not limited to, liquids, gels, pastes, dispersions and the like.

The liquid laundry detergent may comprise water and/or a non-aqueous solvent. Non-limiting examples of suitable non-aqueous solvents include 1,2-Propanediol, glycerol, sorbitol, dipropylene glycol, tripropyleneglycol, or a mixture thereof. The solvent typically makes up the mass balance of the liquid laundry detergent composition, and typically may contribute from 10% to 80% of the weight of the liquid laundry detergent composition.

Typical liquid laundry detergent compositions have a pH between 6 and 10, more typically between 6.5 and 8.9, most typically between 7 and 8. The pH of the liquid laundry detergent composition may be measured as a 10% dilution in demineralized water at 20° C.

In one embodiment, the detergent composition disclosed herein is a solid particulate laundry detergent composition. The term solid particulate detergent composition’ refers to any laundry detergent that is a free-flowing solid particulate detergent composition, typically in the form of a powder.

The solid particulate laundry detergent composition may comprise a solid filler to provide for adjustment of the concentration of the active matter in the detergent composition. The most commonly used solid filler for this purpose is sodium sulfate, however any suitable filler can be used. The solid filler typically accounts for about 30% to about 80% of the weight of the solid particulate laundry detergent composition.

In a typical embodiment, the detergent composition comprises:
a) about 0.005% to about 10% by weight of at least one polysaccharide derivative;
b) about 0.005% to about 10% by weight of at least one pectin;
c) about 0.1% to about 70% by weight of a surfactant system; and
d) optionally at least one solvent or at least one solid filler.

In another typical embodiment, the detergent composition comprises:
a) about 0.005% to about 10% by weight of at least one cellulose derivative;
b) about 0.005% to about 10% by weight of at least one pectin;
c) about 0.1% to about 70% by weight of a surfactant system; and
d) optionally at least one solvent or at least one solid filler.

In another typical embodiment, the detergent composition comprises:
a) about 0.005% to about 10% by weight of at least one cellulose ether;
b) about 0.005% to about 10% by weight of at least one pectin;
c) about 0.1% to about 70% by weight of a surfactant system; and
d) optionally at least one solvent or at least one solid filler.

In another typical embodiment, the detergent composition comprises:
a) about 0.005% to about 10% by weight of at least one carboxymethyl cellulose;
b) about 0.005% to about 10% by weight of at least one pectin;
c) about 0.1% to about 70% by weight of a surfactant system; and
d) optionally at least one solvent or at least one solid filler.

In another typical embodiment, the detergent composition comprises:
a) about 0.005% to about 10% by weight of at least one carboxymethyl cellulose as described above;
b) about 0.005% to about 10% by weight of at least one pectin as described above;
c) about 0.1% to about 70% by weight of a surfactant system as described above; and
d) optionally at least one solvent or at least one solid filler as described above.

In another typical embodiment, the laundry detergent composition comprises:
a) about 0.01% to about 5% by weight of a carboxymethyl cellulose having a molecular weight (Mw) of from about 1,000 Dalton (Da) to about 80,000 Dalton (Da);
b) about 0.01% to about 5% by weight of a pectin having a degree of acetylation (DAc) of at least 10%;
c) about 0.1% to about 70% by weight of a surfactant system comprising one or more surfactants selected from anionic surfactants, non-ionic surfactants, and mixtures thereof;
d) optionally at least one solvent or at least one solid filler, wherein the optional solvent is selected from water, non-aqueous solvents, or a mixture thereof, and wherein the optional solid filler is sodium sulfate.

In another typical embodiment, the laundry detergent composition comprises:
a) about 0.01% to about 5% by weight of a carboxymethyl cellulose having a molecular weight (Mw) of from about 1,000 Dalton (Da) to about 80,000 Dalton (Da) and a degree of substitution (Ds) of from about 0.3 to about 0.8;
b) about 0.01% to about 5% by weight of a pectin having a having a degree of acetylation (DAc) of at least 10% and a degree of methylation (DM) of at least 50%;
c) about 0.1% to about 70% by weight of a surfactant system comprising one or more surfactants selected from anionic surfactants, non-ionic surfactants, and mixtures thereof;
d) optionally at least one solvent or at least one solid filler, wherein the optional solvent is selected from water, 1,2-Propanediol, glycerol, sorbitol, dipropylene glycol, tripropyleneglycol, or a mixture thereof, and wherein the optional solid filler is sodium sulfate.

In another typical embodiment, the laundry detergent composition comprises:
a) about 0.05% to about 2% by weight of a carboxymethyl cellulose having a molecular weight (Mw) of from about 1,000 Dalton (Da) to about 80,000 Dalton (Da) and a degree of substitution (Ds) of from about 0.3 to about 0.8;
b) about 0.05% to about 2% by weight of a pectin having a having a degree of acetylation (DAc) of at least 10%, a degree of methylation (DM) of at least 50%, and a molecular weight (Mw) of from about 30,000 Dalton (Da) to about 300,000 Dalton (Da);
c) about 10% to about 40% by weight of a surfactant system comprising one or more surfactants selected from linear alkylbenzene sulphonates, alkoxylated alkyl sulphates, fatty acids, alcohol alkoxylates, and mixtures thereof;
d) optionally at least one solvent or at least one solid filler, wherein the optional solvent is selected from water, 1,2-Propanediol, glycerol, sorbitol, dipropylene glycol, tripropyleneglycol, or a mixture thereof, and wherein the optional solid filler is sodium sulfate.

In some embodiments, the detergent compositions of the present disclosure may be in the form of a pourable liquid (e.g., packaged in a plastic bottle with a pour spout), may be in the form of a free-flowing particulate (e.g., packaged in a cardboard box), or may be comprised in a water-soluble unit dose article. Water-soluble unit dose articles (commonly referred to as “laundry detergent pods”) are liked by consumers as they are convenient and efficient to use, and usually comprise a sealed water-soluble pouch having at least one internal compartment containing a detergent composition (e.g., as described in EP3441445).

A further aspect of the present disclosure is a process for washing synthetic fabrics comprising the steps of;
a. Combining the detergent composition according to the present disclosure with sufficient water to dilute the detergent composition by a factor of between 300 and 3000 fold, typically between 300 and 800 fold to form a wash liquor;
b. Combining the wash liquor with at least one synthetic fabric to be washed.

The process may be a hand wash operation or may be used in an automatic machine synthetic fabric wash operation.

Another aspect of the present disclosure is the use of a blend of pectin and a polysaccharide derivative, typically a carboxymethyl cellulose, as an anti-redeposition agent for synthetic fibers. Specifically, the blend is used as an anti-redeposition agent in a laundry detergent for synthetic fibers.

It is noted that various elements of the present disclosure, including but not limited to typical ranges for the various parameters, can be combined unless they are mutually exclusive.

### EXAMPLES

The present disclosure will be elucidated by the following examples without being limited thereto or thereby.

### Equipment and Chemicals

The following equipment and chemicals were used in the worked examples that follow:
Wash Apparatus: Copley Scientific Terg-O-Tometer
Whiteness measurement: Konica Minolta Spectrophotometer CM-3600d. Calibrated by primary reference papers (CIE Whiteness D65/10° and ISO Brightness) from Inventia AB, Sweden. Secondary calibration was done by reference fabrics (CIE Whiteness D65/10° and Ganz Griesser) from Hohenstein Laboratories GmbH&Co.KG, Germany.
Test swatches: Knitted Cotton (5 cm×5 cm)
   Polycotton (5 cm×5 cm)
   Polyester (5 cm×5 cm)
Soil: Carbon Black & 5 cm×5 cm 4×C-S-61 Beef fat, coloured with Sudan red from Center for Testmaterials B.V., The Netherlands
Hard water: 18 dH water—7 liters
   2,048 g CaCl₂·H₂O
   1,575 g MgCl₂·6 H₂O
Hard water was prepared the day before testing using Ultrapure water.
Carboxymethylcellulose: Weight average molecular weight 4700 g/mol,
Degree of substitution (Ds) 0.75

### Pectins:

| Pectin | Source | Supplier |
|---|---|---|
| Genu pectin type YM-115-L | Citrus | CP Kelco |
| Genu pectin 150 USA-SAG type A | Citrus | CP Kelco |
| Genu Beta Pectin | Sugar beet | CP Kelco |
| Betawell Pectin TQ-L | Sugar beet | Cosun |
| Apple Pectin HM-RS 1 | Apple | T.B.Pectin |

### Determination of Anti-Redeposition Property

Prior to anti-redeposition testing, test swatches were prepared by washing in a washing machine with Cotton cycle, 60° C., without detergent. The washed test swatches were allowed to air dry, ironed flat, and the initial whiteness values for each test swatch measured by spectrophotometer (Konica Minolta Spectrophotometer CM-3600d).

The anti-redeposition property of a sample was measured using a Tergotometer (Copley Scientific, Nottingham, United Kingdom).

For each test sample, a pot was filled with 800 mL of water with a water hardness of 18° dH and at a temperature of 25° C. CMC and/or pectin were added to the pot and stirred for 5 minutes. Four test swatches of each fabric type were added to the pot and mixed for 5 minutes. Carbon black (320 mg), beef fat (4 swatches), and a liquid detergent were then added to the pot, and the wash program started. For each sample, the swatches underwent washing with agitation of 200 rpm and at a temperature of 30° C., after which the swatches underwent rinsing in water with a water hardness of 18° dH and at a temperature of 25° C. Total washing time was 60 minutes and total rinsing time was 15 minutes. Swatches were then dried overnight at 25° C. and then ironed.

The final reflectance of each swatch was then measured by spectrophotometer (Konica Minolta Spectrophotometer CM-3600d). Each test was replicated four times, and the difference in measured value between the initial measurement and the final measurement was calculated and then averaged. The greater the increase in average measured value (ACIE Whiteness), the whiter (less grey) the fabric swatch was, and consequently the more effective the anti-redeposition property of the test sample.

### Example 1 [Comparative]

In this example, the anti-redeposition properties of CMC or pectin (Betawell Pectin TQ-L) on cellulosic fibers (knitted cotton, polycotton) and synthetic fibers (polyester) was tested. 3,077 g of a commercially available detergent (“Neutral Sensitive Skin”, Unilever) was added to the pot, and CMC or pectin was dosed at 1% (based on the detergent). The results are shown in Table 1.

TABLE 1
[Comparative]

| | | Knitted Cotton | Polycotton | Polyester |
|---|---|---|---|---|
| Ex. | | (ΔCIE Whiteness) | (ΔCIE Whiteness) | (ΔCIE Whiteness) |
| 1A | CMC | 35.87 | 16.76 | −4.72 |
| 1B | Pectin | 13.05 | 1.94 | 5.56 |

The results confirm that CMC alone is an effective anti-redeposition agent for cellulosic fibers (knitted cotton, polycotton), but not for synthetic fibers (polyester; the addition of CMC increased deposition of soil onto the synthetic fibers, hence the negative ACIE Whiteness value). Pectin alone was found to have unimpressive anti-redeposition properties for all tested fibers.

### Example 2

Example 1 was repeated for the polyester sample, except 1% of a blend of CMC-pectin in varying weight ratios was used. The results are shown in Table 2.

TABLE 2

| | | Polyester |
|---|---|---|
| Ex. | CMC:Pectin | (ΔCIE Whiteness) |
| 1A | 100:0 | −4.72 |
| 2A | 75:25 | 15.91 |
| 2B | 50:50 | 19.22 |
| 2C | 40:60 | 10.36 |
| 2D | 30:70 | 18.08 |
| 2E | 20:80 | 11.53 |
| 2F | 10:90 | 14.04 |
| 1B | 0:100 | 5.56 |

Irrespective of the ratio of CMC to pectin, a substantial (synergic) improvement in anti-redeposition properties was observed for the synthetic fibers when using a blend of CMC and pectin (Examples 2A-2F) vs using each component separately (Examples 1A-1B).

### Example 3

Example 1B (no CMC) was repeated for a variety of different pectins. The results are shown in Table 3.

TABLE 3
[Comparative - no CMC]

| | | Polyester |
|---|---|---|
| Ex. | Pectin | (ΔCIE Whiteness) |
| 1B | Betawell Pectine TQ-L | 5.56 |
| 3A | Genu pectin type YM-115-L | 4.48 |
| 3B | Genu pectin 150 USA-SAG type A | 4.87 |
| 3C | Genu Beta Pectin | 7.83 |
| 3D | Apple Pectin HM-RS 1 | −1.39 |

Example 2D was then repeated for the above pectins (70:30, pectin: CMC blend). The results are shown in Table 4:

TABLE 4

| | Pectin | Polyester |
|---|---|---|
| Ex. | (70:30 blend Pectin:CMC) | (ΔCIE Whiteness) |
| 2D | Betawell Pectine TQ-L | 18.08 |
| 3E | Genu pectin type YM-115-L | 9.25 |
| 3F | Genu pectin 150 USA-SAG type A | 7.64 |
| 3G | Genu Beta Pectin | 16.66 |
| 3H | Apple Pectin HM-RS 1 | 9.70 |

The CMC/pectin synergy for the synthetic fibers was once again confirmed by these results.

The best results were observed when using pectins with a high degree of acetylation (DAc>10%; Examples 2D and 3G, both obtained from sugar beet).

### Example 4

Examples 1A, 1B and 2D were repeated with the following surfactant system that was prepared in the laboratory:

| Component | Wt. % |
|---|---|
| Propylene glycol | 3 |
| Citric Acid | 1 |
| Linear Alkylbenzene Sulfonic Acid | 2.9 |
| Sodium Lauryl Ether Sulfate C12-14 EO2 | 12.3 |
| Alcohol ethoxylate (Hoesch LM 70) | 2.8 |
| Coconut fatty acids C8-C18 | 4 |
| Ethanol | 1 |
| pH trim [NaOH] | |
| Water | Balance |

Tests were performed on cellulosic fibers and synthetic fibers, and the results are shown in Table 5.

TABLE 5

| | | Knitted Cotton | Polycotton | Polyester |
|---|---|---|---|---|
| | | (ΔCIE | (ΔCIE | (ΔCIE |
| Ex. | | Whiteness) | Whiteness) | Whiteness) |
| 4A | CMC (1%) | 30.17 | 11.34 | 4.15 |
| [Comp.] | | | | |
| 4B | Pectin (1%) | 7.96 | 7.75 | 20.05 |
| [Comp.] | | | | |
| 4C | 70/30 Pectin/ | 26.21 | 16.14 | 22.86 |
| | CMC (1%) | | | |

The CMC/pectin synergy for the synthetic fibers was once again confirmed by these results, showing that the CMC/pectin synergy exists irrespective of the detergent type used. It was also interesting to note that the anti-redeposition properties of the CMC/pectin blend was at least comparable to the anti-redeposition properties of CMC alone for the cellulosic fibers (knitted cotton, polycotton).

### Example 5

To determine whether the observed synergy with pectin was specific to CMC or more generally applicable to any known anti-redeposition agents, the following examples were performed (equivalent conditions to Example 4) using various synthetic, semi-synthetic and natural polymers (known anti-redeposition agents) and comparing the performance of said polymers to the equivalent polymer-pectin blend. Examples 5A-5M used 1 wt. % polymer or polymer/pectin blend, and the polymer/pectin blends were used in a 30/70 weight ratio.

| | | Knitted Cotton | Polycotton | Polyester |
|---|---|---|---|---|
| | | (ΔCIE | (ΔCIE | (ΔCIE |
| Ex. | | Whiteness) | Whiteness) | Whiteness) |
| 5A | Sokalan HP 20 | 17.98 | 4.82 | 10.19 |
| 5B | Sokalan HP 20/Pectin | 15.80 | 4.95 | 8.15 |
| 5C | Sokalan HP 25 | 19.56 | 13.43 | 18.63 |
| 5D | Sokalan HP 25/Pectin | 15.01 | 6.40 | 6.70 |
| 5E | Sokalan HP 30 | 23.39 | 4.22 | 8.81 |
| 5F | Sokalan HP 30/Pectin | 14.48 | 6.01 | 8.46 |
| 5G | Alcosperse 747 | 15.53 | 6.68 | 13.77 |
| 5H | Alcosperse 747/Pectin | 6.08 | 8.74 | 10.78 |
| 5I | Xanthan gum | 8.16 | 2.73 | 6.66 |
| 5J | Xanthan gum/Pectin | 6.34 | 5.76 | 8.34 |
| 5K | Alcoguard H5941 | 13.66 | 0.74 | 9.11 |
| 5L | Alcoguard H5941/ | 9.02 | 8.64 | 14.14 |
| | Pectin | | | |
| 5M | Pectin | 9.27 | 6.43 | 10.41 |

Sokalan HP 20 (BASF) - Ethoxylated polyethyleneimine [Fully synthetic]
Sokalan HP 25 (BASF) - Modified Polycarboxylate [Fully synthetic]
Sokalan HP 30 (BASF) - Alkoxylated polyethyleneimine [Fully synthetic]
Alcosperse 747 (Nouryon) - Acrylic-styrene copolymer [Fully synthetic]
Alcoguard H5941 (Nouryon) - Amylose-polyacrylate [Polysaccharide derivative]
Xanthan Gum [Natural polysaccharide]

The synergy observed for the pectin-CMC blend was also clearly observed for the blend of pectin and Alcoguard H5941 (another polysaccharide derivative; Ex. 5K-5L showing a superadditive effect for the synthetic fabric when using the blend [5L] vs each component separately [5K, 5M]). Pectin appeared to significantly hinder the performance of fully synthetic polymers on the synthetic fabric (Ex. 5A.-5H) and did not seem to provide anything substantially more than an additive effect with the unmodified (natural) polysaccharide (Ex. 5I-5J). It is not readily apparent why a synergy exists specifically between pectin and polysaccharide derivatives, but the empirical data clearly shows the existence of said synergy between said classes of compounds only.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than to mean ‘consisting of’. All prior teachings acknowledged above are hereby incorporated by reference. No acknowledgement of any prior published document herein should be taken to be an admission or representation that the teaching thereof was common general knowledge in Europe or elsewhere at the date hereof.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A detergent composition comprising a pectin and a polysaccharide derivative.

2. The detergent composition of claim 1, wherein the polysaccharide derivative is a cellulose derivative.

3. The detergent composition of claim 2, wherein the cellulose derivative is a carboxymethyl cellulose that has a weight average molecular weight of from 1,000 Da to 300,000 Da, as determined using GPC, Pullulan standards.

4. The detergent composition of claim 2, wherein the cellulose derivative is a carboxymethyl cellulose that has a degree of substitution (Ds) of less than 0.8.

5. The detergent composition of claim 1, wherein the polysaccharide derivative is chosen from a carboxymethyl cellulose having a weight average molecular weight of from about 1,000 Da to about 80,000 Da using GPC, Pullulan standards, a polysaccharide-polyacrylate hybrid polymer, and combinations thereof, and
wherein the pectin has a degree of acetylation of at least 10%.

6. The detergent composition of claim 1, wherein the pectin has a degree of methylation of at least 50%.

7. The detergent composition of claim 1, wherein the pectin has a degree of methylation of at least 50% and a degree of acetylation of at least 10%.

8. The detergent composition of claim 1, wherein the pectin is a sugar beet pectin.

9. The detergent composition of claim 1, wherein the pectin has a weight average molecular weight of from about 30,000 Da to about 300,000 Da as determined using GPC, Pullulan standards.

10. The detergent composition of claim 1, wherein the weight ratio of pectin to the polysaccharide derivative is 95:5 to 5:95.

11. The detergent composition of claim 1 that is a liquid laundry detergent composition.

12. The detergent composition of claim 1 that is a solid particulate laundry detergent composition.

13. The detergent composition of claim 1, wherein the detergent composition comprises from about 0.01% to about 70% by weight of a surfactant system.

14. The detergent composition of claim 13, wherein the surfactant system comprises one or more anionic surfactants, non-ionic surfactants, or mixtures thereof.

14. The detergent composition of claim 1 wherein the polysaccharide derivative is a carboxymethyl cellulose that has a weight average molecular weight of from about 1,000 Da to about 80,000 Da as determined using GPC, Pullulan standards and that has a degree of substitution (Ds) of less than 0.8.

15. The detergent composition of claim 14 wherein the pectin has a degree of acetylation of at least 10%.

16. The detergent composition of claim 14 wherein the pectin has a degree of methylation of at least 50%.

17. The detergent composition of claim 14 wherein the pectin has a degree of methylation of at least 50% and a degree of acetylation of at least 10%.

18. The detergent composition of claim 16 wherein the weight ratio of pectin to the carboxymethyl cellulose is 95:5 to 5:95.

19. The detergent composition of claim 17 wherein the weight ratio of pectin to the carboxymethyl cellulose is 95:5 to 5:95.

20. A method of washing a synthetic fabric comprising contacting said synthetic fabric with a wash liquor comprising a detergent composition according to claim 1.
